(19) United States
(12) Patent Application Publication
(10) Pub. No.: US 2026/0109559 A1
(43) Pub. Date: Apr. 23, 2026

(54) DRIVERLESS TRANSPORT SYSTEM INCLUDING PASSIVE TRANSFER STATION FOR COUPLING TO CONTINUOUS CONVEYORS

(71) Applicant: SSI Schäfer Automation GmbH (DE), Giebelstadt (DE)

(72) Inventors: Ralf KLEEDÖRFER, Marktheidenfeld (DE); Vitali HUCK, Bremerhaven (DE)

(21) Appl. No.: 19/168,476

(22) PCT Filed: Feb. 13, 2024
(86) PCT No.: PCT/EP2024/053628

§ 371 Date: Sep. 24, 2025

(30) Foreign Application Priority Data
Mar. 29, 2023 (DE) 10 2023 107 995.6

(51) Int. Cl. B65G 67/08; B65G 67/24

(52) U.S. Cl. CPC B65G 67/08; B65G 67/24

(57) ABSTRACT

A DTS and a method for exchanging transport items between a DTV and a transfer station. The driverless transport system, DTS, has at least one ramp-like transfer station configured to exchange a transport item with a continuous conveyor horizontally couplable thereto; and a driverless transport vehicle (DTV) for transporting the transport item from and/or to the at least one transfer station; wherein the DTV has a load-handling device forming a flat transport surface on which the transport item rests during a transport travel, wherein the load-handling device, in an end portion thereof, comprises at least one finger member switchable between a raised position and a lowered position, wherein the at least one finger member in the raised position protrudes from the transport surface; wherein each of the transfer stations consists (exclusively) of an inclined non-driven multi-track transfer conveyor which is configured to be meshingly underpassed by the DTV such that: in case, while the transport item rests on the transfer conveyor, the transport item is received by the DTV from the transfer conveyor by the DTV exiting the transfer conveyor and the at least one finger member being in the raised position; and in case, while the transport item rests on the transfer conveyor, the transport item is delivered by the DTV to the continuous conveyor by the DTV entering the transfer conveyor and the at least one finger member being in the raised position.

### CROSS-REFERENCE TO RELATED APPLICATIONS

This application is a national stage application under 35 U.S.C. 371 of PCT Application No. PCT/EP2024/053628 having an international filing date of 13 Feb. 2024, which designated the United States, which PCT application claimed the benefit of German Application No. 10 2023 107 995.6, filed 29 Mar. 2023, each of which are incorporated herein by reference in their entirety.

### BACKGROUND

The present disclosure relates generally to an intralogistically used driverless transport system (DTS), and in particular to automatic loading and unloading of driverless transport vehicles (DTVs) at transfer stations coupled to conventional continuous conveyors.

DE 20 2018 101 313 U1 shows various loading and unloading stations operated with DTVs, each of which has on its respective upper side a load-handling device formed of elongate webs or (supporting) slats arranged parallel to the travelling direction, which are spaced apart from each other perpendicular to the travelling direction and whose upper sides together define a flat (i.e. planar, level, straight, and/or non-curved) transport plane, or transport surface, on which the transport items rest or sit during transport. The webs are designed in a comb-like, or slat-like manner, in order to meshingly receive and/or deliver the transport items. The receiving and delivering preferably takes place passively, in particular inertia-based, in that the DTV drives through rigidly arranged receiving, or delivering, members of a loading station (receiving) or of an unloading station (delivering), wherein the members of the stations are correspondingly arranged in a comb-like manner such that the members and the webs do not collide with each other during passage. For the purpose of receiving or delivering, the webs have at their upstream or downstream ends in the travelling direction fingers which serve as drivers (cf. FIGS. 5 and 6 there), pushers (cf. FIG. 14 there), or stops (cf. FIG. 10 there). The fingers project perpendicularly (upward) from the transport plane, and are immovably fixed to the corresponding ends of the webs.

DE 10 2014 111 396 A1 shows types of DTVs of different heights whose slat-like or comb-like webs, which form the load-handling device, have at their downstream or upstream ends rigid fingers protruding from the transport level. The fingers may also be designed to be movable by being extendible and retractable in a height direction. Further, an unloading station and a loading station (cf. FIG. 9 there) are used with so-called “spaghetti conveyors” (cf. FIG. 8A there). The spaghetti conveyors comprise driven individual conveyors, which are arranged apart from each other perpendicular to the travelling direction and oriented parallel to the travelling direction in order to mesh with the webs of the DTVs during passage of the DTVs. Alternatively, the webs or slats may also be brush-like, formed by bristles (cf. FIG. 8B there) which are elastically be formable so that they are pressed down by the spaghetti conveyor during the passage of the DTV through the stations, and which are sufficiently stiff so that the items are held at a minimum distance relative to the upper side of the vehicle during the transport.

Since the spaghetti conveyor is driven actively, it is difficult to design the individual conveyors to be narrow. The drive requires space. The cantilevered suspension is made more difficult because of the drive being present. The spaghetti conveyor must be monitored by external sensors in order to synchronize the DTVs with the delivering and receiving of the transport items. The control effort during an exchange of transport items is considerable if the spaghetti conveyor is not operated permanently, which would be energetically disadvantageous.

In general, in meshing exchange of the transport goods items between the DTVs and a transfer conveyor, the DTVs travel through the transfer conveyor (passage) and thus under a longitudinally connected main conveyor. These DTVs must also emerge again from under the main conveyor. For this purpose, space is required, which cannot be used otherwise, in the planning of the travelling routes of the DTVs. The layout freedom of a planner is thereby restricted, which is undesirable. In addition, the main conveyor must be positioned higher than usual, which can make retrofitting of existing systems more difficult. The DTVs could also be designed lower. In that case, however, a more complex supporting structure would be required for passing under the main conveyor.

U.S. Pat. No. 4,508,484 B shows a loading and unloading station being meshingly passed through by a DTV, cf. FIG. 8. The station comprises a frame (not illustrated) including an integrated chain conveyor KF, the conveyor chains K of which are arranged laterally with respect to the passing DTV and which is driven by racks ZS arranged on an upper side of a housing of the DTV and beneath webs S. During the passage, upon delivery from left to right in FIG. 8, the racks ZS engage with a drive pinion AR of the chain conveyor KF which can be coupled, via a clutch (not illustrated) and a transmission (not illustrated), to the two lateral conveyor chains K. The chain conveyor KF comprises, on its input side, an ascending portion AA which transitions into a horizontal portion HA where the transport item TG is separated from the DTV. Thereafter, the transport item TG can be handed over from the chain conveyor KF to a driven continuous conveyor SF arranged downstream by driving the chain conveyor KF via a motor (not illustrated).

Although in this solution external sensors are omitted, which effect synchronization of the movements of the DTV and the transfer conveyor during the exchange of transport items, the transmitting drive is disadvantageous. The DTVs and the transfer conveyor come into mechanical contact for the transmission, which requires precise alignment and results in increased wear. Smaller height differences between the racks on the DTVs and the drive pinions of the transfer conveyor can result in mechanical blockage if the racks are positioned too high, or lead to a failure of the drive of the transfer conveyor if the racks are positioned too low. The racks arranged on the left and right of the DTVs must be positioned accurately in the longitudinal direction of the DTVs in order to synchronously operate the left and right conveyor chains of the transfer conveyor. The mechanical transmission thus places high demands on the positioning accuracy, which are difficult to meet in practical everyday operation.

The FIGS. 1-4 of JP 1986 050 853 B2 disclose a transfer station coupled on one side to a DTS and on the other side to a driven roller conveyor. A transport platform (LHD) of the DTV is equipped with two vertically retractable pushing plates, which can be activated individually. The transport platform meshingly interacts with the transfer station, which has an inclined portion and a horizontal portion, and is constructed with two tracks of freely rotating rollers. The horizontal portion is coupled to the driven roller conveyor. Upon delivery of the transport item to the roller conveyor, the rear pushing plate first pushes the transport item resting on the platform onto the ascending portion and then onto the horizontal portion while the DTV enters the transfer station, whereby the separation of the transport item from the platform takes place. Then, the DTV (with the pushing plate raised or lowered) drives backward out of the transfer station again. Upon receiving the transport item, this item is conveyed by the roller conveyor onto the non-driven horizontal portion of the transfer station so that the DTV can underpass the transport item (with lowered pushing plates). Then, the front pushing plate is extended in order to push off the transport item while the DTV exits the transfer station backward again. During this process, the transport item is pushed from the horizontal portion into the inclined portion, and from there onto the platform. This solution requires a large amount of space, which is often not available, in particular in production facilities. A transfer cycle takes long because the DTV has to travel long distances. The LHD of the DTV is complex since one, in particular switchable, pushing element is required on each of the input and output sides.

Additional prior art can be found in the documents: DE 10 2016 203 778 B4, DE 10 2015 003 758 A1, and DE 10 2015 114 370 A1.

Therefore, it is an object of the present disclosure to provide a DTS and an exchange method overcoming at least partially the above-mentioned disadvantages.

This object is solved by a driverless transport system, DTS, comprising: at least one, in particular passive, ramp-like transfer station being configured to exchange a transport item with a, in particular driven, continuous conveyor couplable thereto horizontally; and a driverless transport vehicle, DTV, for transporting the transport item from and to the at least one transfer station; wherein the DTV (on its upper side) comprises a load-handling device, LHD, preferably formed of webs aligned along a travelling direction, which may coincide with the longitudinal direction of the DTV, the LHD forming a flat transport surface on which the transport item rests during a transport travel, wherein the load-handling device comprises in a (with respect to a forward travel preferably downstream, i.e. front) end portion thereof at least one finger member switchable between a raised position and a lowered position, wherein the at least one finger member in the raised position protrudes (upward) from the transport surface; wherein each of the transfer stations (exclusively) consists of an inclined non-driven, in particular freely rotating, multi-track transfer conveyor which is configured to be meshingly underpassed by the DTV such that: in case, while the transport item rests on the transfer conveyor, the transport item is received by the (pulling-off) DTV from the transfer conveyor by the DTV exiting the transfer conveyor and the at least one finger member being in the raised position; and in case, while the transport item rests on the transfer conveyor, the transport item is delivered by the (pushing) DTV to the continuous conveyor by the DTV entering the transfer conveyor and the at least one finger member being in the raised position.

The arrangement is space-saving. The DTV underpasses merely the transfer conveyor formed inclined. The DTV does not underpass the continuous conveyor. The transfer station is short in the longitudinal direction because no horizontal transfer conveyor is provided adjacent to the inclined conveyor at the end. The inclined transfer conveyor is coupled directly to the continuous conveyor.

The cycle time for exchanging one transport item is shortened because the DTV travels shorter distances.

During the exchange of the transport item between the DTV and the continuous conveyor, the DTS does not require any sensor system in the area of the conveying system. This means that sensors are not provided which activate and deactivate the various conveyors (transfer conveyor and/or continuous conveyor) in order to effect transfer between the conveyors. The continuous conveyor may also be a (passive) gravity conveyor. The transport item is exchanged solely by the movement of the DTV. In particular, any sensor system is required in the area of the transfer conveyor and the transfer station, respectively.

A further advantage is to be seen in that the transfer conveyor of the transfer station does not need to be driven. This means that corresponding drives can be dispensed with. The transport item is moved solely by the DTV. Thus, the movement takes place passively. Also, by this measure, a control effort, energy consumption, and investment costs can be minimized.

The switchable finger member allows underpassing the transfer conveyor without colliding with the transport item already located on the transfer conveyor. When receiving, the transport item, the finger member is set into its raised position for pulling the transport item off the transfer conveyor. When delivering, the finger member is brought into its raised position for pushing the transport item located on the transfer conveyor onto the continuous conveyor as the DTV enters the transfer station. It is sufficient to control the DTV. A sensor system and/or actuators in the area of the transfer station and the continuous conveyor are eliminated.

Since the transport item is meshingly exchanged between the DTV and the separation station, the non-driven configuration of the transfer conveyor is particularly advantageous. The transfer conveyor is designed without any drive. The saving of corresponding drive components allows a narrow or slim dimensioning of the transfer conveyor, in particular in a direction perpendicular to the travelling direction of the DTV. Prong-like individual conveyors of the transfer conveyor can thus be arranged in a large number distributed over the width of the transfer station, or of the DTV. In this way, the load of the transport item to be exchanged can be distributed better (in a transverse direction Z) across the transfer conveyor.

Preferably, the transfer conveyor is configured to be meshingly underpassed by the DTV such that in case, while the transport item rests on the transfer conveyor, the transport item is received by the DTV from the transfer conveyor by the DTV (empty) entering the transfer conveyor and the at least one finger member being in the lowered position, and subsequently exiting the transfer conveyor while the at least one finger member is in the raised position in order to pull off the transport item.

Again, the DTV underpasses the transfer conveyor only, but not the continuous conveyor, which is space-saving.

Only the fact that the at least one finger member is switchable between the raised and the lowered position makes it possible to use the same DTV (and the one or more finger members on one side of the LHD only) for delivering and for receiving (with the, in particular same, transfer station). Only the lowered position allows the DTV to enter the transfer station that is already loaded with the transport item. Thereafter, the finger member is brought into its raised position in order to pull the transport item off the transfer station. This makes it possible to dispense with a drive at the transfer station. The DTV is moved forward and backward so that the DTV does not have to underpass the continuous conveyor.

In particular, the load-handling device comprises, in its opposite end portion, at least one additional, preferably immovable, finger member protruding (upward) from the transport surface.

The additional finger member(s) support the delivery of the transport item from the DTV to the transfer station by the additional finger member pushing the transport item, in particular uphill, onto the transfer station.

Little space is required because the DTV does not underpass the continuous conveyor. This is particularly advantageous in production facilities where little space is available.

The control of the DTV and/or the way points of the route network are configured for pilgrim-step movement. The pilgrim-step movement prevents the DTV from having to underpass, or pass through, the continuous conveyor upon exchange of the transport item. The “footprint” of the (overall) arrangement is reduced. In designing the arrangement, only a single path for the DTV has to be considered during the exchange. The DTV enters and exits the transfer station on the same path.

Further, it is advantageous if: the at least one finger member includes a first finger and a second finger; the first finger in its raised position preferably protrudes higher from the transport surface than the second finger in its raised position; the first finger is in the lower position and the second finger is in its raised position while the DTV receives the transport item from the transfer conveyor; and the first finger is in its raised position while the DTV delivers the transport item from the transfer conveyor to the continuous conveyor.

In this configuration, an (optional, vertical) step is provided between the transfer conveyor and the continuous conveyor, which must be overcome upon delivering the transport item from the DTV to the continuous conveyor. Therefore, the first finger is preferably configured longer than the second finger. In particular, the first finger extends (vertically) beyond the conveying plane of the continuous conveyor. The first finger is used when delivering, whereas the second finger is used when receiving. The second (shorter) finger allows an immersion of the corresponding finger member into the transfer station even in a state in which another transport item, which is already located on the continuous conveyor, is provided for the next receiving. This other transport item may overlap the transfer station (in the entry and exit direction). Nevertheless, the second finger in its raised position does not collide with the other transport items already provided during the pulling-off of the desired transport item.

Preferably, the at least one ramp-like transfer station comprises a first transfer station for (indirectly) delivering the transport item from the DTV (via the transfer station) to the continuous conveyor, and a second transfer station for (indirectly) receiving the transport item by the DTV (via the transfer station) from the continuous conveyor.

The receiving station and the delivery station can be configured differently, which allows during a receiving movement a step between the receiving station and the continuous conveyor, where one or more stops can be provided for retaining the transport item to be received during the initial pushing back by the DTV onto the transfer conveyor.

The delivery station, on the other hand, can be configured in a stepless manner so that the DTV can push without resistance the transport item to be delivered onto the continuous conveyor.

Preferably, the transfer conveyor of the first transfer station (delivery station) is substantially couplable steplessly to the continuous conveyor, as explained above.

In particular, the transfer conveyor of the first transfer station comprises a locking device allowing movement of the transport item only toward the continuous conveyor, for example, in that the rollers of the transfer conveyor are rotatable only uphill, which in particular supports a delivery by means of a pilgrim-step movement. Alternatively, a fixed wedge-shaped, or spring-loaded, stop could be provided at the lower end of the transfer conveyor preventing a rolling down of the transport item.

In this way, it can be prevented that the transport item delivered to the transfer station unintentionally slips off the transfer station, in particular while the DTV performs the pilgrim-step movement, i.e. travels back, in order to finally push the transport item delivered to the transfer station onto the continuous conveyor by means of a forward travel.

Preferably, at least one (passive) stop is provided at a lower end of the transfer conveyor.

In particular, highest point of this at least one stop is lower than the transport surface of the DTV. This is the case when the transfer conveyor of a receiving station is located lower than the continuous conveyor, i.e. when the conveying plane of the transfer conveyor and the continuous conveyor form a vertical step with each other, see FIG. 9A.

If the conveying planes of the transfer conveyor and the continuous conveyor merge stepless into one another, as is generally the case or can be the case with a delivery station, the lower stop can also project beyond the height of the transport surface of the DTV, see FIG. 9B.

The stop causes the transport item to not unintentionally slip off the transfer station.

In particular, the transfer conveyor rises (continuously) towards the continuous conveyor.

The transfer conveyor uses gravity for positioning the transport item to be exchanged at predetermined positions for receiving and delivering. The inclination of the transfer conveyor supports the connecting and releasing of the transport item with or from the LHD.

In particular, the transfer conveyor is formed by at least two individual conveyors being arranged spaced apart from one another perpendicular to a travelling direction of the DTV so that the webs can meshingly immerse into a free space between the individual conveyors.

In this way, the meshing exchange of the transport item between the DTV and the transfer station is made possible.

Further, the object is solved by a method for exchanging a transport item between a driverless transport vehicle, DTV, and a, in particular driven, continuous conveyor via a ramp-like transfer station consisting of a non-driven (exclusively) inclined transfer conveyor, wherein the transfer station and the DTV are configured to meshingly exchange the transport item while the DTV either enters the transfer station or exits the transfer station, wherein the DTV comprises a load-handling device, LHD, which comprises at its downstream end at least one finger member protruding in a raised position from a flat transport surface, defined by the LHD, and in a lowered position being positioned below the transport surface; wherein the method comprises the steps of: in case of delivering the transport item from the DTV to the continuous conveyor: meshingly entering the transfer station with the loaded DTV parallel to the transfer conveyor until the DTV has completely pushed the transport item onto the transfer conveyor; then exiting the transfer station with the DTV, while the at least one finger member is in the lowered position and the transport item rests on the transfer conveyor; and then again meshingly entering the transfer station with the DTV, while the at least one finger member is in its raised position until the transport item has been pushed completely by the at least one finger member onto the continuous conveyor; or in case of receiving the transport item from the continuous conveyor by the DTV: conveying the transport item by the continuous conveyor from the continuous conveyor onto the transfer conveyor of the transfer station; stopping the transport item, preferably passively, on the transfer conveyor; then meshingly entering the transfer station with the empty DTV, while the at least one finger member is in the lowered position, until the at least one finger member is positioned behind a rear edge of the transport item and a front edge rests on the LHD; then moving the at least one finger member from the lowered position into the raised position; and finally meshingly exiting the transfer station with the DTV so that the at least one finger member in its raised position pushes the transport item off the transfer conveyor.

Preferably, the DTV travels forward when entering and backward, in a direction opposite to the forward direction, when exiting.

In particular, the continuous conveyor is actively driven in a supporting manner during the delivery in order to pull the transport item onto itself.

Preferably, the continuous conveyor is actively driven in a supporting manner during the receiving in order to hold the transport item on the transfer conveyor while the initially empty DTV meshingly enters the transfer station.

It is understood that the features of the present invention mentioned above and explained in more detail below cannot be used only in the respectively indicated combination but also in other combinations or alone, without departing from the scope of the claimed invention.

### BRIEF DESCRIPTION OF THE DRAWINGS

Further features and advantages of the invention result from the following description of preferred embodiments with reference to the drawings. The drawings show:

FIG. 1 a block diagram of an intralogistics system;

FIG. 2 a perspective view of a driverless transport system including a delivery station for a DTV within an intralogistics system;

FIG. 3 a perspective view of a DTS including a receiving station within an intralogistics system;

FIG. 4 a block diagram of a DTV;

FIG. 5 a block diagram of a transfer station;

FIGS. 6A-6H are sequences of different states during delivering a transport item from a DTV via a transfer station onto a continuous conveyor coupled thereto;

FIGS. 7A-7H are sequences of different states during receiving a transport item from a DTV via a transfer station onto a continuous conveyor coupled thereto;

FIG. 8 a side view of a known transfer station including a known DTV; and

FIGS. 9A-9B show a schematic side view of a receiving station arranged in steps (FIG. 9A) and a schematic side view of a delivery station arranged steplessly (FIG. 9B).

### DETAILED DESCRIPTION

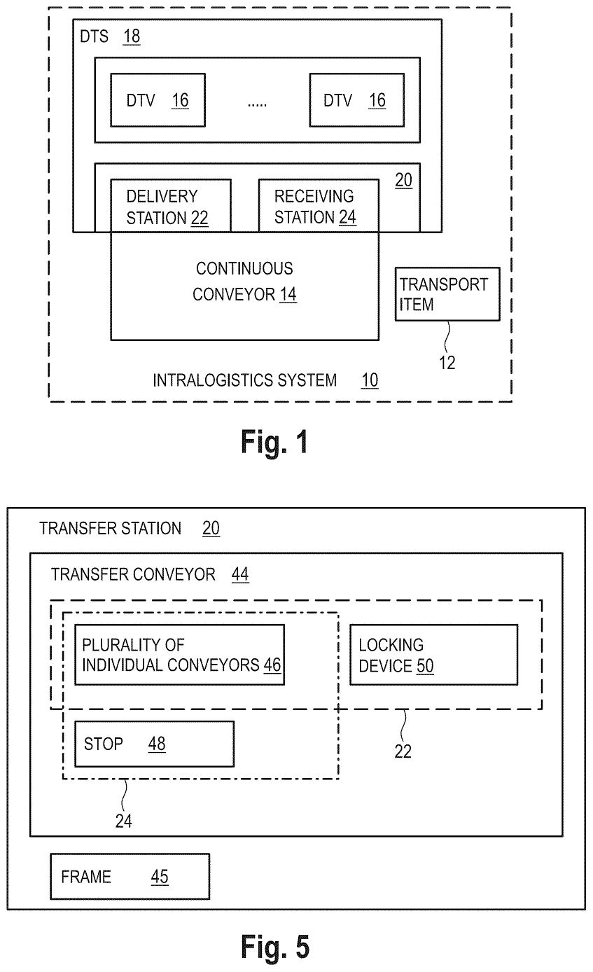

The invention is used, for example, in an intralogistics system 10 of FIG. 1. The system 10 may be a storage and picking system (not illustrated), such as a distribution facility or the like, where transport items 12 are to be exchanged between a warehouse (not illustrated) and, for example, picking and packing stations (not illustrated), or between the warehouse and a continuous conveyor 14 which can represent a network for conveying connection to arbitrary workstations. However, the system 10 can also be used in production, where workstations are to be supplied with material and where empty transport containers, waste, and/or finished (intermediate) products are to be retrieved and, if necessary, also to be stored again. As usual in (intra-)logistics, a longitudinal direction is hereinafter designated by “X”, a transverse direction by “Z”, and a height direction by “Y”. The directions X, Y, and Z preferably define a Cartesian coordinate system.

A (transport) “item” is hereinafter understood, for example, as a storage and/or picking unit which is to be transported within the intralogistics system 10 from a starting point (source) to a destination point (sink). The item, which is also referred to as transport item 12, may comprise a (storage) load carrier (not shown) as well as an article (not shown). However, the item 12 may also comprise only the article itself if no storage load carrier is required.

As (storage) load carriers, for example, pallets, mesh boxes, containers, bins, cartons, trays, (overhead-conveyor) pouches and the like can be used. An “article” may be one single piece good, or a cohesive group of pre-packaged (sometimes also different) piece goods, which is then also referred to as packaging unit (PU) or as case. Articles are (smallest) units, which can be distinguished by type of article of an article assortment. Piece goods are individualized articles which can be distinguished and handled individually.

One or more driverless transport vehicles (DTVs) 16 are part of a driverless transport system (DTS) 18. The explanations hereinafter apply to each of the DTVs 16 used in the DTS 18.

The DTV 16 is an automated, preferably forcibly guided, vehicle that performs transport tasks in the intralogistics system 10 quickly, inexpensively, and in a scalable manner. The DTV 16 can be operated completely autonomously by determining its route through the system 10 independently and finding the same without forced guidance (and a central control). In particular, the DTV 16 may be a “WEASEL” (registered trademark of the SSI Schäfer Company).

The DTV 16 is an discontinuous conveyor, and moves preferably along a pre-defined transport network (not shown) which can be formed, for example, by lines that may be glued or painted onto a floor of a building and connect the way points of the network with each other. Alternatively, discrete (grid) points may also be used as way points for navigation, which can be connected to one another via virtual lines. Along this transport network, for example, RFID markers can be provided as an implementation of way points. A line between two adjacent way points is hereinafter referred to as a (conveying) route. It is understood that the routes can be realized in terms of virtual connection lines, for example, when an internal GPS or laser navigation system is used. The same applies to the way points.

The DTS 18 comprises, in addition to the at least one DTV 16, one or more transfer stations 20. The transfer stations 20 can be implemented as delivery stations (first transfer stations) 22 and/or as receiving stations (second transfer stations) 24. One or more of the transfer stations 20 may be configured such that they can be used both as a delivery station 22 and receiving station 24 without further modification.

It is understood that the system 10 can include further components being not shown, which will be explained in more detail below.

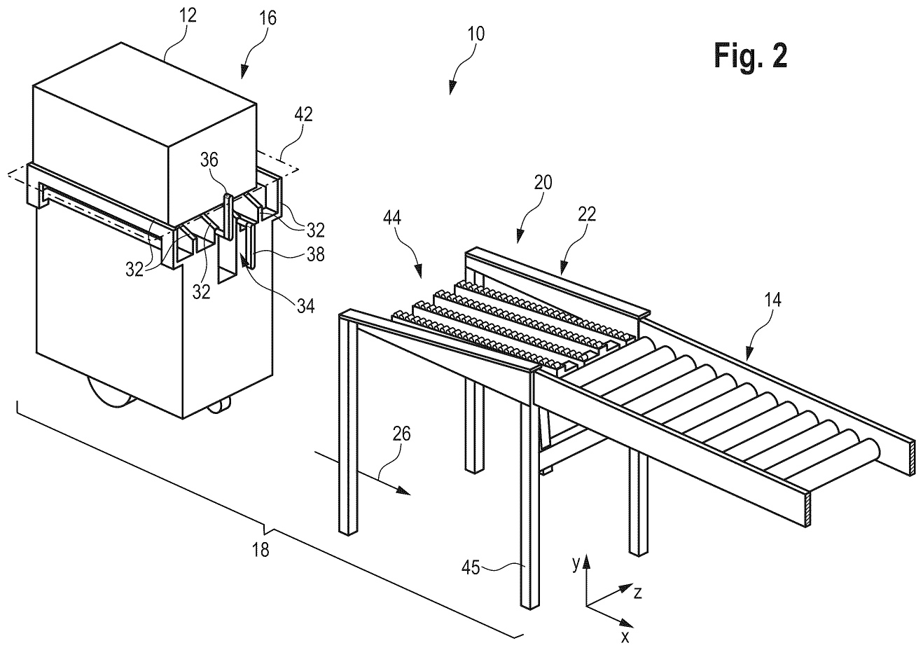

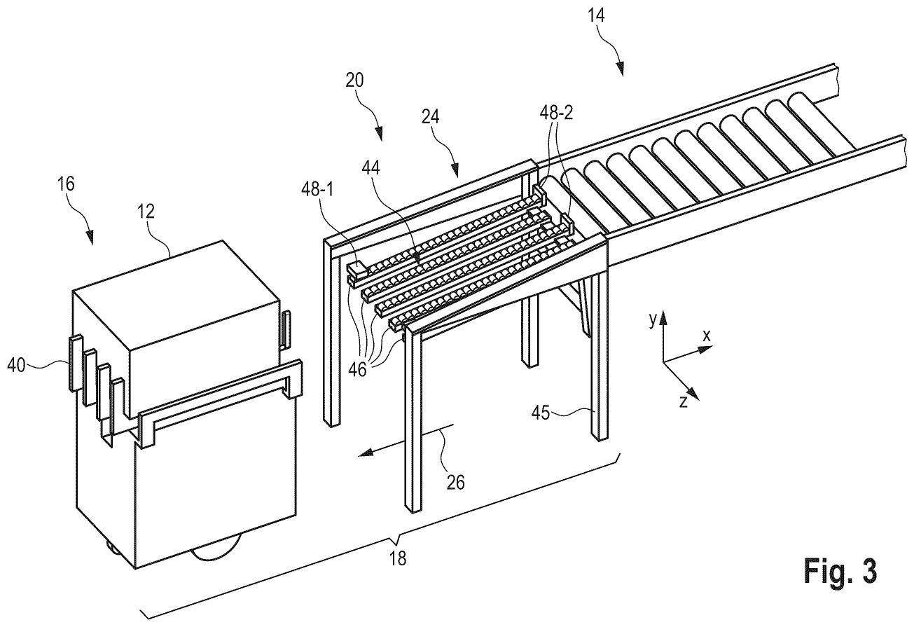

FIGS. 2 and 3 respectively show an exemplary transfer station 20 coupled directly to a continuous conveyor 14 (shown only partially), which is exemplarily illustrated as a roller conveyor. The continuous conveyor 14 transports the transport items from and to workstations and/or storage locations. It is understood that the continuous conveyor 14 may also be implemented by a belt conveyor, chain conveyor, or the like.

FIG. 2 illustrates an exemplary delivery station 22 via which the DTV 16 can deliver one or more transport items 12 to the continuous conveyor 14 (passively, i.e. without it being driven) by the DTV 16 entering (linearly) in a travelling direction 26, here parallel to the direction X, the transfer station 20 of FIG. 2. FIG. 3 illustrates an exemplary receiving station 24 via which the DTV 16 can retrieve one or more transport items 12 from the continuous conveyor 14 (passively) by the DTV 16 exiting (linearly) in the travelling direction 26, here parallel but opposite to the direction X, the transfer station 20 of FIG. 3. The delivery station 22 of FIG. 2 and the receiving station 24 of FIG. 3 are configured differently but could also be configured identically.

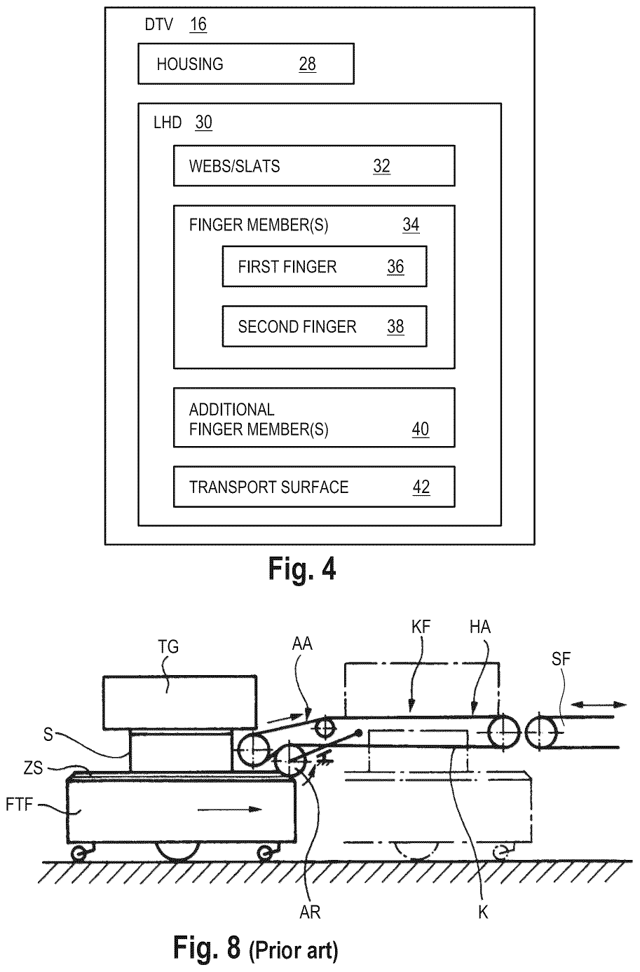

As illustrated in FIG. 4, each of the DTVs 16 has a housing 28 on the upper side of which, cf. FIGS. 2 and 3, a load-handling device (LHD) 30 is provided.

The LHD 30 is formed of multiple webs, or slats, 32, as described above. The webs 32 are aligned parallel to the longitudinal direction of the DTV 16, parallel to the direction X in FIGS. 2 and 3, and are spaced apart from each other in the transverse direction Z. The webs 32 project upward along the direction Y from the housing 28, and define free spaces between them into which transfer conveyors (not shown) of the transfer stations 20 may meshingly immerse while the DTV 16 enters or exits the transfer station 20 parallel to the direction X. The upper sides of the webs 32 define together a flat transport surface 42 on which the one or more transport items 12 rest during travel with the DTV 16. Outer lateral webs 32 may be formed higher, cf. FIGS. 2 and 3, for securing the transport items 12 against lateral slipping (in the direction Z) during a transport travel.

The LHD 30 further comprises at least one (switchable) finger member 34 switchable between raised position and lowered position and being provided in one of the end portions (positioned in the longitudinal direction of the DTV 16) of the webs 32. In FIG. 2, two finger members 34 are shown by way of example, which may comprise one or more first fingers 36 and/or one or more second fingers 38.

In FIG. 2, by way of example, one first finger 36 and one second finger 38 are provided in a (here downstream) end portion of the transport surface 42. The second finger 38 is shown in its lowered position, while the first finger 36 is shown in its (preferably vertically oriented) raised position. The first finger 36 is preferably formed longer than the second finger 38 so that the first finger 36 projects higher above the transport surface 42 than the second finger 38 in its (not shown) raised position. The function of the fingers 36 and 38 of different lengths will be explained in more detail below.

Also, it is understood that in FIG. 2 the first finger 36, when delivering the transport item 12 from the DTV 16 to the transfer station 20 or the delivery station 22, could likewise be in its lowered position, since for the delivery to the station 20 or 22 none of the fingers 36 and 38 is necessarily required, cf. FIG. 5. Also, it is understood that the fingers 36 and 38 can also be provided at other webs 32 than the central webs 32. The more centrally the fingers 36 and 38 are arranged, the fewer fingers 36 and 38 are needed in order to prevent rotation of the transport item 12 during the delivery to the station 20.

In general, it is true that each transfer station 20 is ramp-like and comprises a, not actively, driven multi-track transfer conveyor 44, preferably rising (continuously) toward the continuous conveyor 14, as shown in FIG. 5, which is integrated into a frame 45 positioned stationary, as shown in FIGS. 2 and 3. The transfer conveyor 44 is directly coupled to the continuous conveyor 14. The DTV 16 is indirectly coupled to the continuous conveyor 14 by connecting the transfer station 20 therebetween upon an exchange of the transport item 12. The transfer conveyor 44 has no drive of its own, i.e. is not actively driven, so that a (passive) movement of transport items 12 positioned on the transfer conveyor 44 can be caused solely by the DTV 16 or the continuous conveyor 14. The transfer conveyor 44 has multiple tracks by providing several (linear) individual conveyors 46 being oriented parallel to the webs 32 of the LHD 30 of the DTV 16, when the DTV enters or exits the transfer station 20. At least two individual conveyors 46 are provided which mesh (contactlessly) with the webs 32. This means that the individual conveyors 46 preferably engage contactlessly in the free spaces between the webs 32 for receiving or delivering the transport item 12. The individual conveyors 32 are arranged inclined so that they immerse from above into the free spaces while the DTV enters the transfer station 20. Further, the individual conveyors 46 are dimensioned and inclined such that an end portion of the individual conveyor 46, which is facing away from the continuous conveyor 14, is positioned lower than the transport surface 42 but higher than the upper side of the housing 28. In FIGS. 2 and 3, four individual conveyors 46 are shown by way of example. It is understood that more or less than four individual conveyors 46 may be used, in particular dependent on a number of free spaces between the webs 32.

The receiving station 24 of FIG. 3 comprises, in comparison to the delivery station 22 of FIG. 2, at least one stop 48, preferably in each end portion of the transfer conveyor 44, and in particular in the lower end portion. Each of the stops 48 is preferably immovable in order to save actuators (and sensors). Height dimension of each stop 48 is selected preferably such that the transport item 12 can be moved over the respective stop 48 during a (horizontally directed) movement in a preferred movement direction, whereas the transport item 12 abuts the stop 48 during movement in the opposite direction.

In FIG. 3, for example, five stops 48 are provided. More or less stops 48 may be used. By way of example, two stops 48-1 are provided in the respective lower end region, facing away from the continuous conveyor 14, of the two laterally outer individual conveyors 46, whereas the other exemplary three stops 48-2 are provided in the respective (upper) end region, facing the continuous conveyor 14, of the laterally outer individual conveyors 46 and of the central individual conveyor 46. The stops 48-2 have a height dimension adapted to an optionally provided height difference between the transfer conveyor 44 and the continuous conveyor 14 such that the transport item 12 can slide over the stops 48-2 when the transport item 12 is supplied from the continuous conveyor to the transfer station 20 for being received by the DTV 16.

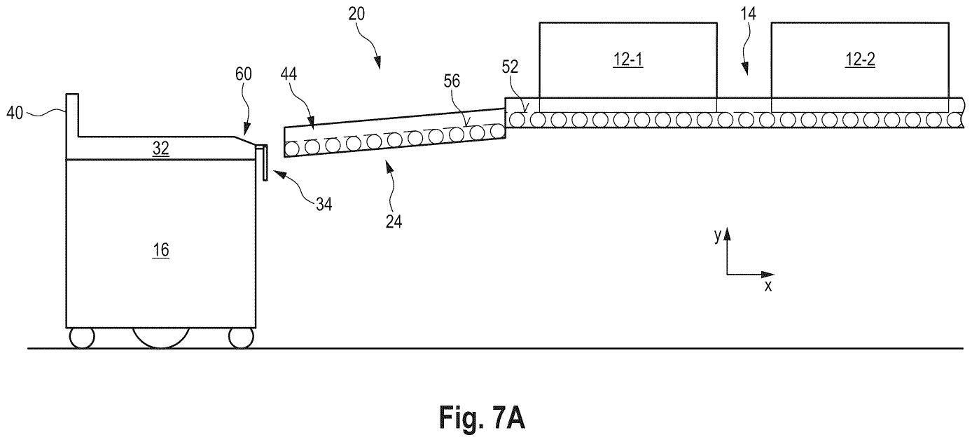

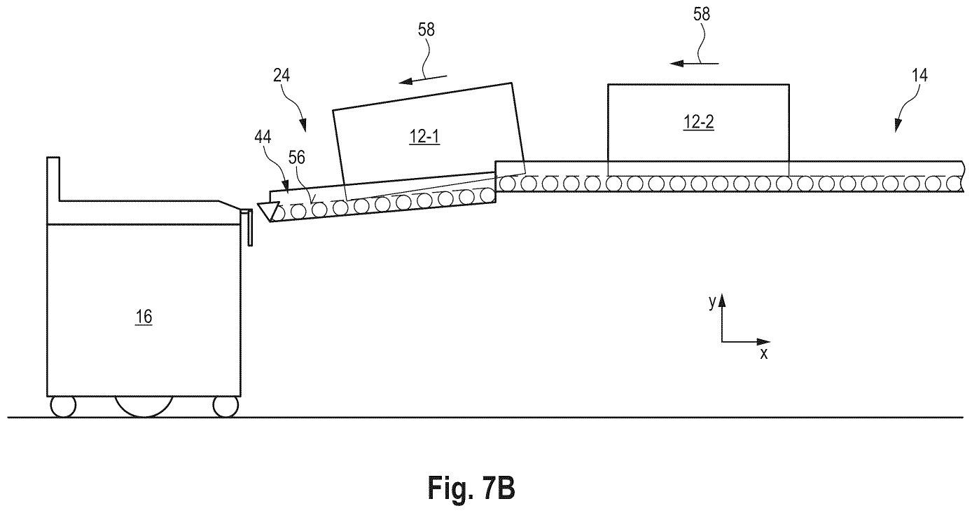

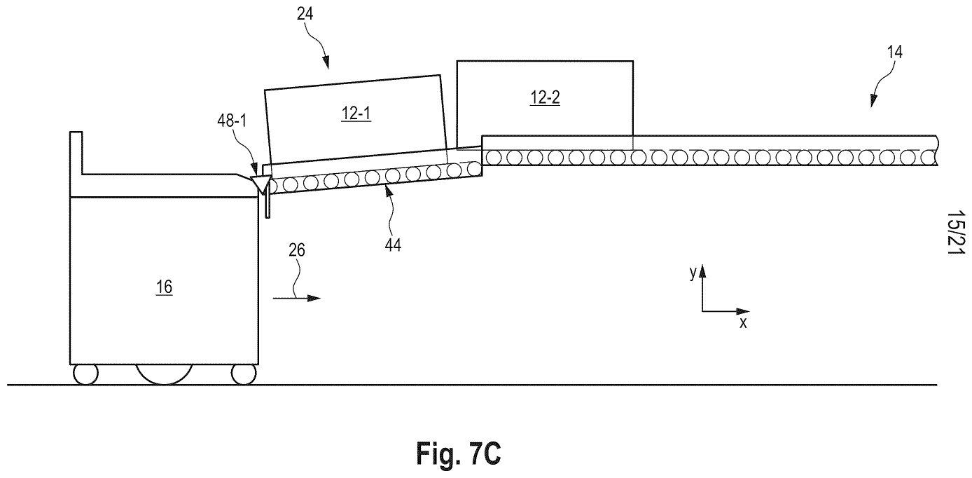

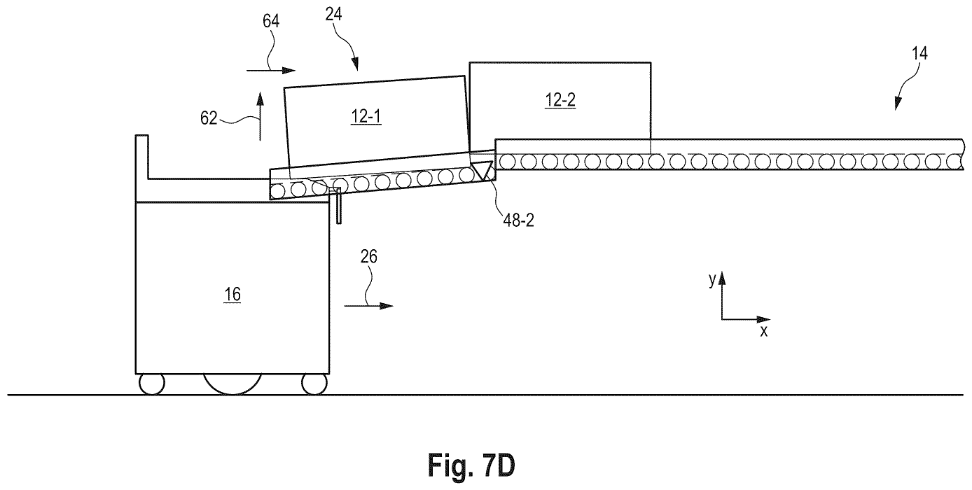

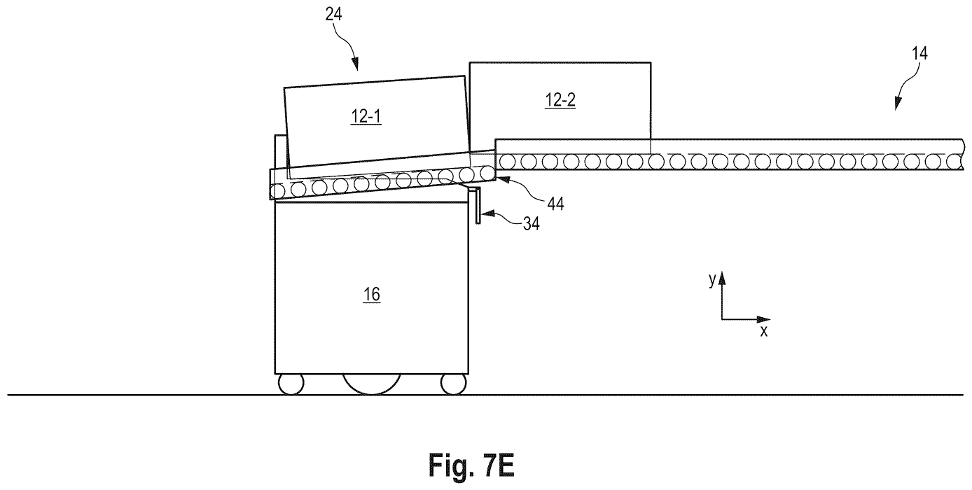

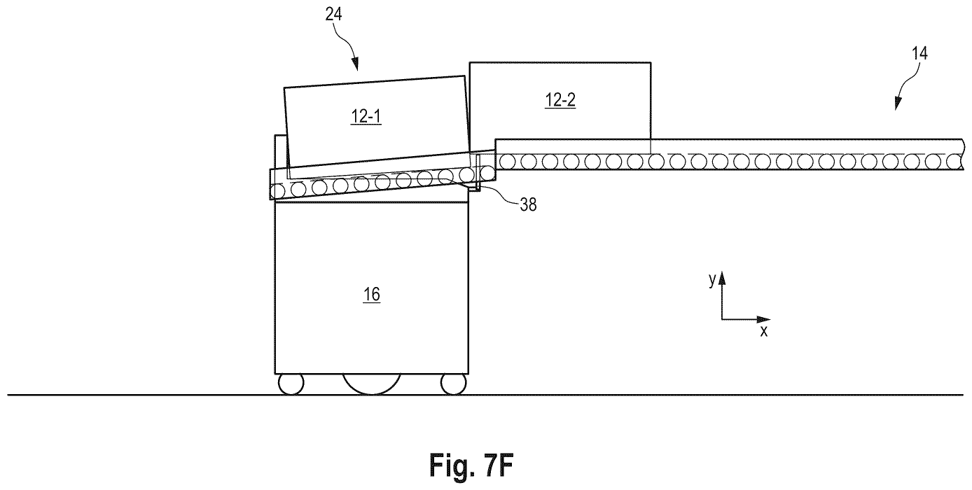

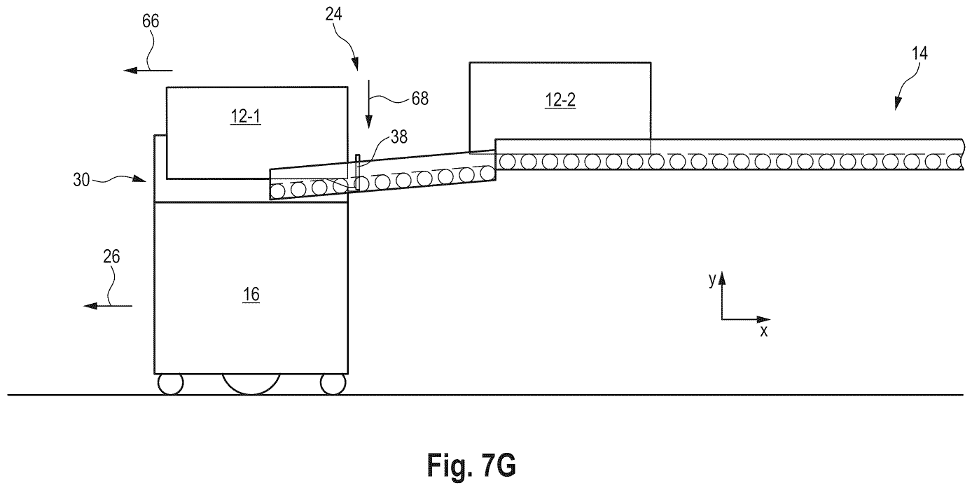

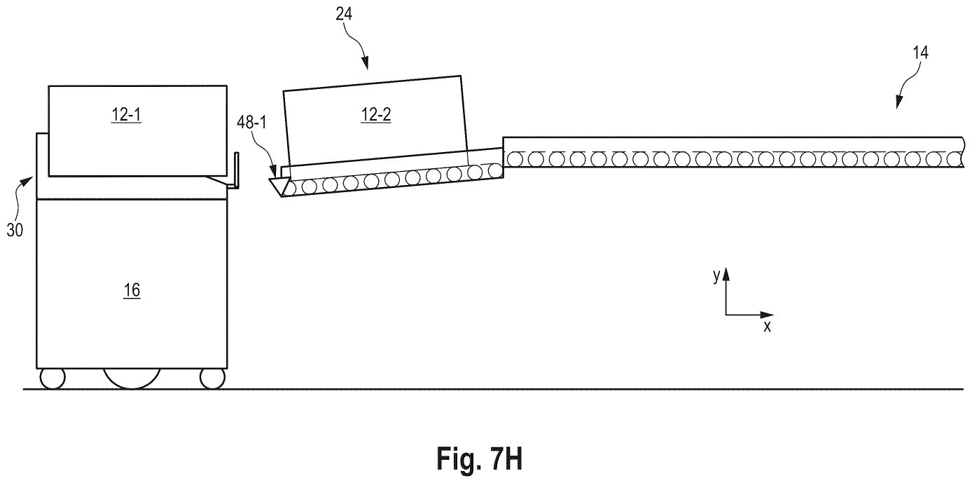

The stops 48-2 prevent that the transport item 12 located on the transfer conveyor 44 is moved back on the continuous conveyor 14 during a receiving movement in which the DTV 16 underpasses the transport item in the positive direction X. The one or more stops 48-2 can be omitted if the continuous conveyor 14 is operated in the negative direction X during the receiving by the DTV 16 in FIG. 3, so that the transport item 12 cannot be pushed back from the DTV 16 onto the continuous conveyor 14. Alternatively or additionally, another transport item 12-2 may be positioned on the continuous conveyor 14, which prevents pushing back of the transport item 12-1 to be received, see FIG. 7D.

The front lower stops 48-1 of the transfer conveyor 44 of the receiving station (cf. FIG. 7) are arranged such that the highest points (upper edges) of the stops 48-1 are lower than the transport surface 42 of the webs 32 of the DTV 16. When the DTV 16 is travelling in the direction opposite to the positive direction X (exit), the transport item 12 on the transport surface 42 of the DTV is thus spaced away (raised) from the front stops 48-1, and is in this case no longer retained. The stops 48-1 may be fixed or spring-supported so that they can be pressed down in the direction Y.

The transfer conveyor 44 of the receiving station 24 of FIG. 3 can form, with the continuous conveyor 14, a step, which is preferably not present in the transfer conveyor 44 of the delivery station 22 of FIG. 2. The stepless transition in FIG. 2 between the transfer conveyor 44 and the continuous conveyor facilitates the DTV 16 pushing the transport items 12 from the transfer station 20 onto the continuous conveyor 14.

In FIG. 2, the delivery of the transport items 12 from the delivery station 22 to the continuous conveyor 14, which is caused by the pushing movement of the DTV 16, can be supported additionally to the pushing movement by the DTV 16, which will be explained in more detail below, by operating the continuous conveyor 14 in the positive direction X in FIG. 2. In this case, it is even possible to select the first finger 36 so short that it does not project in its raised position beyond an upper side of the planar conveying surface of the continuous conveyor 14 since the transport item 12, once it tips from the slope of the non-driven transfer conveyor 44 into the horizontal of the continuous conveyor 14, lies on the continuous conveyor 14 and is thus completely under the control of the driven continuous conveyor 14.

The individual conveyors 46 of FIGS. 2 and 3 can be implemented, for example, by so-called roller rails. Each of the roller rails has a plurality of (freely rotating) rollers which are supported one behind the other in a linear rail-shaped frame.

In the delivery station 22 of FIG. 2, the rollers can be additionally configured to be rotatable in one direction only, so that the transport items 12 can only be moved in the positive direction X (uphill) onto the continuous conveyor 14. This means that the transport items 12, despite the inclination of the individual conveyor 46 of the transfer conveyor 44 of FIG. 2, cannot slide off the delivery station 22 in the negative direction X due to gravity. Alternatively, a fixed wedge-shaped stop, or a spring-loaded stop, may be provided at the lower end of the transfer conveyor, which stop prevents the transport item from rolling down.

In the receiving station 24 of FIG. 3, the rollers can be configured to freely rotate in both directions, because the stops 48 prevent unintentional removal of the transport items 12 from the transfer conveyor 44.

It is understood that the individual conveyor 46 may be implemented in general by other types of conveyors, such as sliding conveyors, sliding surfaces, belt conveyors, or the like. In general, the transfer conveyor 44 can also be implemented by (non-driven passive) sliding surfaces, both in the receiving station 24 and in the delivery station 22.

However, the transfer conveyor 44 of the delivery station 22 and of the receiving station 24 have in common that the individual conveyors 44 thereof are mounted in a prong-like manner and are cantilevered on the frame 45 of the respective transfer station 20. The individual conveyors 46 are mounted on an end of the frame 20 facing the continuous conveyor 14 such that, at the end facing away, they hang freely in the air in order to interact meshingly, preferably contactlessly, with the LHD 30 of the DTVs 16. At the end facing away, the individual conveyors 46 are positioned lower than at the end facing toward. The individual conveyors 46 are oriented parallel to each other, preferably with the same inclination relative to the horizontal.

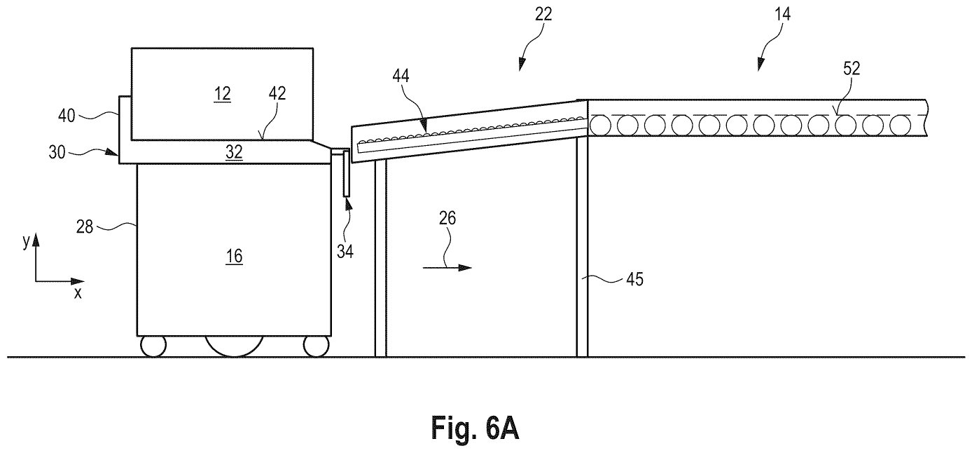

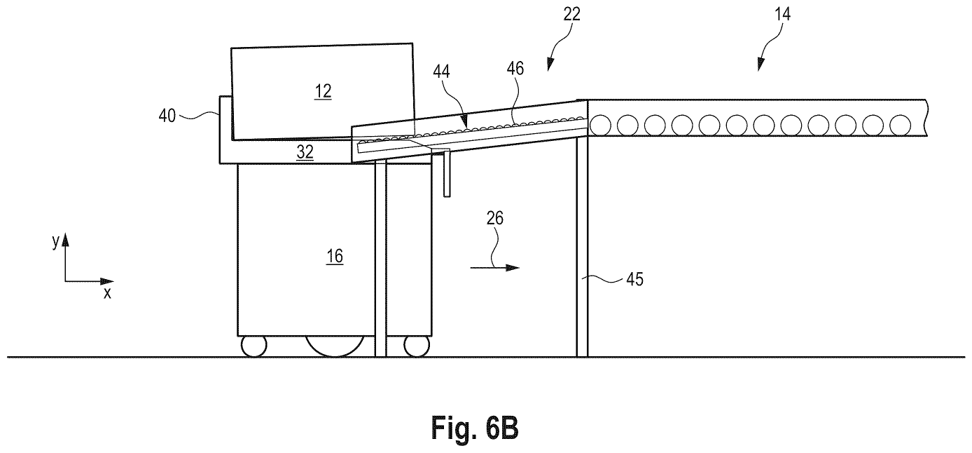

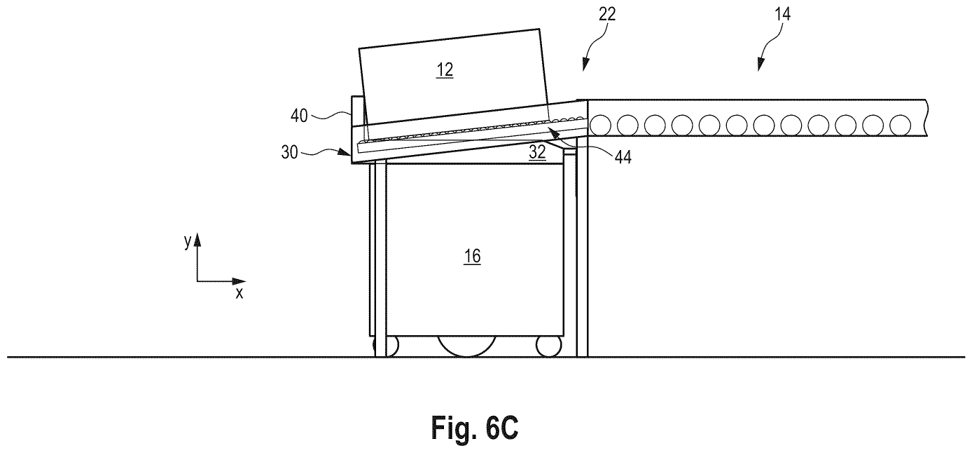

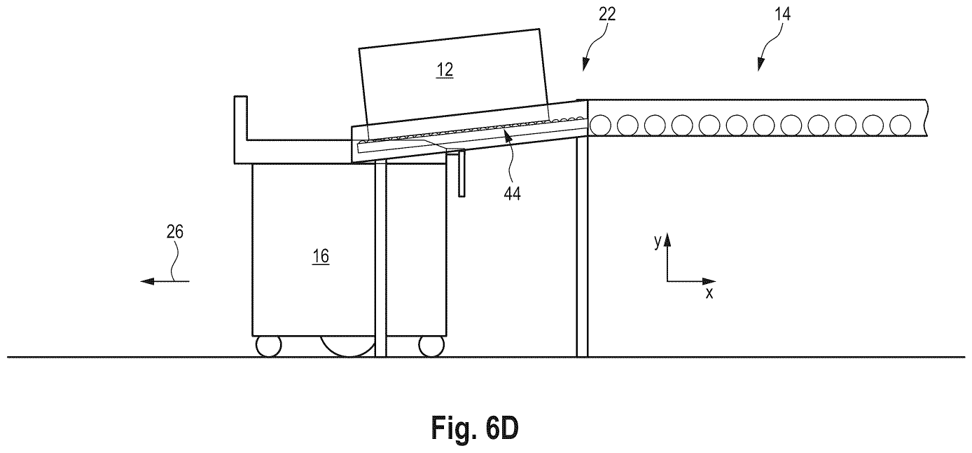

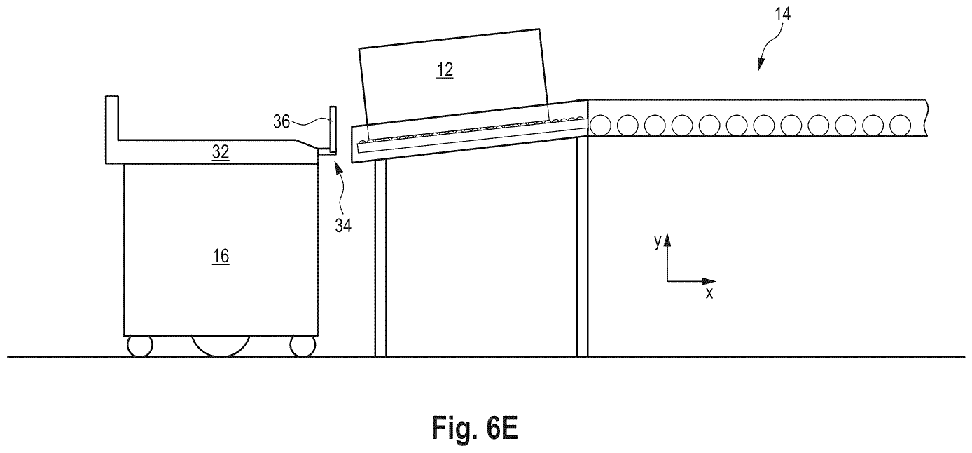

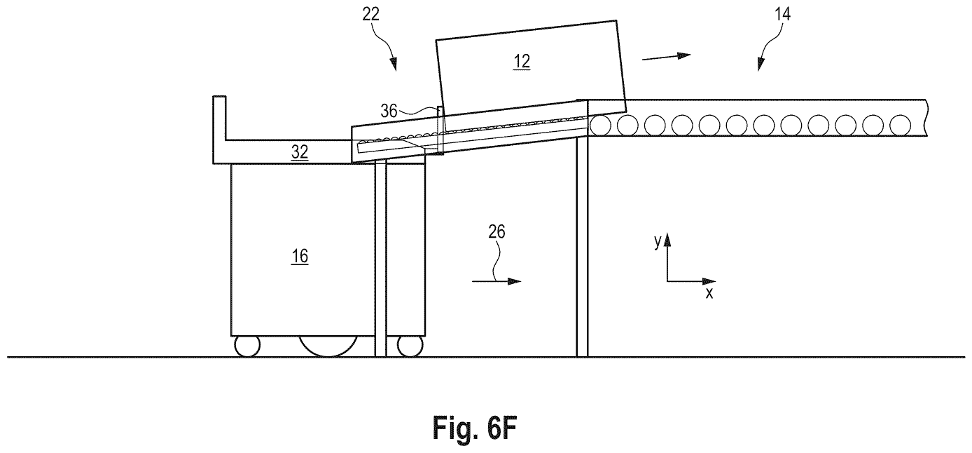

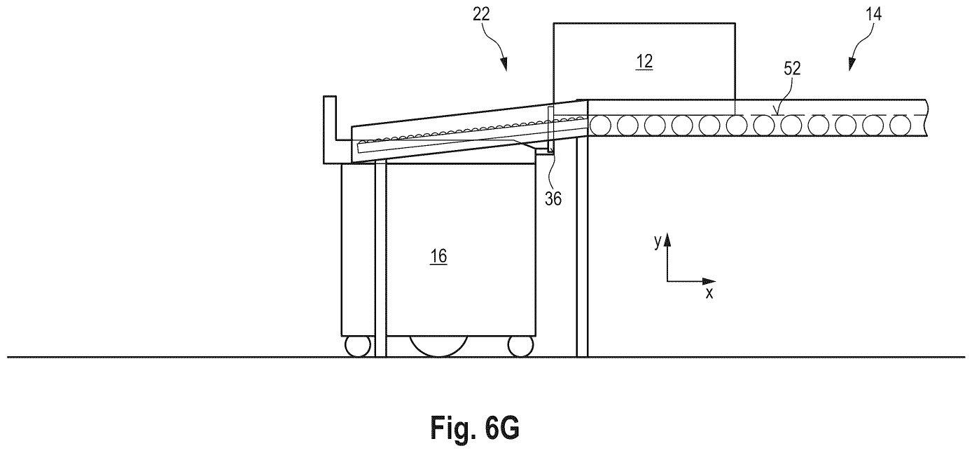

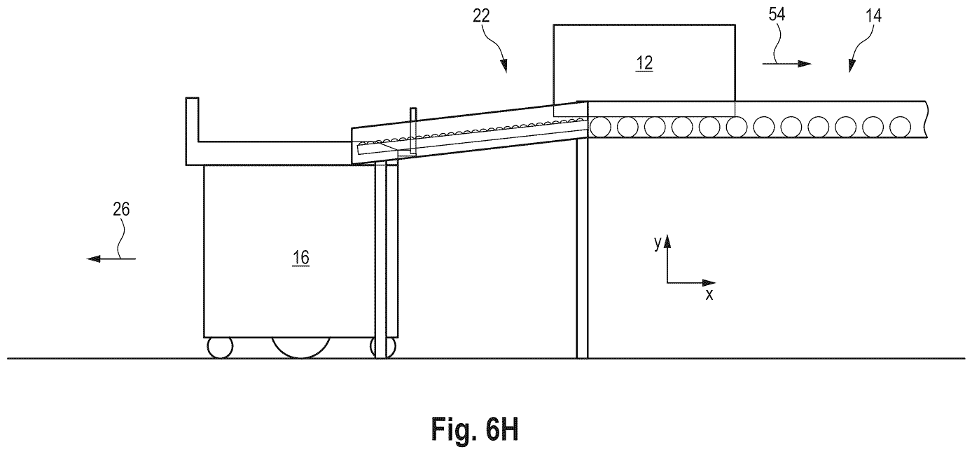

Hereinafter, sequence of delivery (FIG. 6) and sequence of receiving (FIG. 7) will be described.

FIGS. 6 and 7 show side views of the delivery station 22 and the receiving station 24 of FIGS. 2 and 3 at successive points in time during delivery of a transport item and receiving of a transport item, respectively. The DTV 16 may also be the same as in FIGS. 2 and 3.

FIG. 6A shows an initial situation in which the (loaded) DTV 16, which can be loaded with one single transport item 12, enters the delivery station 22 parallel to the positive direction X, see travelling direction 26. It is understood that the DTV 16 could also be loaded with more than one transport item 12. The DTV 16 meshingly enters the transfer conveyor 44 of the delivery station 22 linear along the direction X.

The webs 32 (oriented parallel to the direction X) of the LHD 30 can be provided at their end upstream in the travelling direction 26 with at least one additional finger member 40 (per web 32). The finger members 34 can be in their lowered position so that they are positioned underneath the transport surface 42. Since FIG. 6 uses the DTV 16 of FIG. 2, the DTV 16 is (also) provided with a first finger 36 and a second finger 38, which by way of example are provided at downstream ends of the central webs 32 (e.g., rotatable about the direction X, or extendible in the direction Y).

In the side view of FIG. 6A, it can be clearly seen that the transfer conveyor 44 merges stepless into the continuous conveyor 14, which can be formed, for example, as a (driven) roller conveyor. This means that an upper side (or conveying surface) of the transfer conveyor 44 ends (downstream) at a height being identical to a height of an, for example, horizontally oriented conveying surface, or transport surface, 52 of the continuous conveyor 14 illustrated in FIG. 6A by a dashed line.

In FIG. 6B, the DTV 16 has already entered partially the delivery station 22 and also continues to enter the station 22. The webs 32 and the individual conveyors 46 of the transfer conveyor 44 overlap (contactlessly) at least partially in the direction X and mesh with each other. A front edge of the transport item 12 is already located on the transfer conveyor 44 and slightly lifted from the webs 32. The additional finger members 40 push the transport item 12 in the direction X onto the transfer conveyor 44 and prevent that the transport item 12 falls backward off the DTV 16. The transport item 12 is slightly inclined relative to the DTV 16 by lifting the front edge of the transport item 12.

In FIG. 6C, the DTV 16 has already entered and is completely beneath the delivery station 22. The DTV 16 has stopped and no longer travels in the direction X. The transport item 12 rests exclusively on the transfer conveyor 44. This means that the transport item 12 has been completely lifted off and released from the webs 32 of the LHD 30. Only the additional finger members 40 may still be in contact with a rear side of the transport item 12.

The end of the transfer conveyor 14, which is facing away from the continuous conveyor 14, has fully immersed into the free spaces between the webs 32. This facing-away end lies lower than an upper side of the webs 32.

In FIG. 6D, the DTV 16 travels backward, i.e. in the negative direction X, (meshingly) out of the delivery station 22 again. The transport item 12 remains on the transfer conveyor 44, in particular since the transfer conveyor 44 can be provided with a locking device 50 (cf. FIG. 5) preventing that the transport item 12 moves down from the non-driven transfer conveyor 44. Alternatively, a fixed wedge-shaped stop, or a spring-loaded stop (not shown), may be provided at the lower end of the transfer conveyor 44, which stop prevents the transport item 12 from rolling down.

Once the DTV 16 has exited sufficiently far from the delivery station 22, the at least one finger member 34, here with its first finger 36, can be moved, or switched, from its lowered position into the raised position. In FIG. 6E, by way of example, this can be achieved by a rotational movement of the first finger 36 in the clockwise direction (viewed along the negative direction X).

Then, the DTV 16 is moved forward again, i.e. in the positive direction X, into the delivery station 22, as shown in FIG. 6F, while the transport item 12 located on the transfer conveyor 44 of the delivery station 22 is pushed uphill toward the continuous conveyor 14. This pushing movement is continued at least until the transport item 12 has (completely) left the transfer conveyor 44 and has been delivered to the continuous conveyor 14, as shown in FIG. 6G. The transport item 12 has left the transfer conveyor 44 once the transport item 12 tips from the slope into the horizontal.

In FIG. 6G, the DTV 16 has stopped. The transport item 12 rests solely on the continuous conveyor 14 and is oriented horizontally. The first finger 36 can project in the vertical direction Y beyond the upper side, or transport surface 52, of the continuous conveyor 14. This need not be the case. The length of the first finger 36, or of the corresponding finger member 34, can be selected shorter. The length of the corresponding finger member 34 is to be selected such that the DTV 16 can push the transport item 12 uphill long enough until the transport item 12 tips from the slope (cf. FIG. 6F) into the horizontal onto the continuous conveyor 14 (cf. FIG. 6G).

It is understood that the sequence shown in FIGS. 6E to 6G can also be performed while the DTV 16 is loaded with a new transport item, however, not illustrated in FIG. 6. The DTV 16 is unloaded in the FIGS. 6E to 6F. However, the DTV 16 may carry one or more transport items 12 on its webs 22, while the transport item 12 already located on the transfer conveyor 44 is pushed by the raised first finger 36 in the direction of the continuous conveyor 14. Then, at the same time the one or more transport items 12 being located on the LHD 30 of the DTV 16 are in turn pushed onto the transfer conveyor 44, so that these are located behind the transport item 12 being already positioned on the transfer conveyor 44 (as illustrated in FIGS. 6E to 6G).

It is also understood that the additional finger members 40, which are helpful when loading the delivery station 22, need not necessarily be provided. The additional finger members 40 may also be omitted.

FIG. 6H illustrates the situation where the transport item 12 has been pushed (completely) onto the continuous conveyor 14 and the DTV 16 exits backward the delivery station 22 in the negative direction X. The delivery of the transport item 12 from the DTV 16 onto the continuous conveyor 14, indirectly via the transfer station 20 (delivery station 22), is then completed. Subsequently, additional transport items 12 can be delivered to the delivery station 22, as already explained above. The delivered transport item 12 can be transported away at any time by the continuous conveyor 14 from the position shown in FIG. 6H (cf. arrow 54) by activating a drive of the continuous conveyor 14.

It is understood that the drive of the continuous conveyor 14 during the transfer of the transport item 12 from the transfer conveyor 44 onto the continuous conveyor 14 can be switched on in a supporting manner. In this case, the continuous conveyor 14 actively pulls the transport item 12 onto itself while the DTV 16 pushes the transport item 12 from the transfer conveyor 44 onto the continuous conveyor 14. This is particularly advantageous for heavy transport items 12.

FIG. 7 shows a side view of FIG. 3, wherein some parts which are illustrated in FIG. 3 have been omitted in FIG. 7 for simplifying illustration. FIG. 7 illustrates receiving of a transport item 12 by the DTV 16, via the transfer station 20 (receiving station 24), from the continuous conveyor 14. The DTV 16 and the continuous conveyor 14 are, by way of example, of the same type as in FIGS. 2 and 6. The transfer station 20 is different in FIG. 7 from the one in FIG. 6. However, it is understood that identical transfer stations 20 may also be used.

FIG. 7A shows an initial situation during the receiving. By way of example, two transport items 12-1 and 12-2 are located on the continuous conveyor 14. More or less transport items 12 can be positioned on the continuous conveyor 14. The transport items 12-1 and 12-2 rest on the conveying surface 52 of the continuous conveyor 14. The DTV 16 is positioned in front of the receiving station 24. The finger members 34 are in their lowered positions. The frame 45 of the receiving station 24 is not shown in FIG. 7.

FIG. 7B shows that the two transport items 12-1 and 12-2 are conveyed actively toward the receiving station 24 from the continuous conveyor 14 in the negative direction X. The feeding of the two transport items 12-1 and 12-2 is illustrated by arrows 58. The DTV 16 may still be standing in front of the receiving station 24. The front transport item 12-1 has already largely overcome the step between the transfer conveyor 44 of the receiving station 24 and the continuous conveyor 14. The transport item 12-1 stands with its front edge on the transfer conveyor 44, or on the conveying surface 56 of the transfer station 20 (receiving station 24) defined by the transfer conveyor 44.

In FIG. 7C, the DTV 16 moves forward in the positive direction X. The DTV 16 enters the receiving station 24 in order to receive the transport item 12-1. The transport item 12-1 is positioned completely on the transfer conveyor 44 and is held on the transfer conveyor 44 by the first stops 48-1, cf. FIG. 3. The transport item 12-2 has been conveyed forward (in the negative direction X) by the continuous conveyor 14 to such an extent that a front portion of the transport item 12-2 overlaps with the receiving station 24 in the direction X.

FIG. 7D shows that the DTV 16 has travelled further into the receiving station 24. The transport item 12-1 has been lifted via a start-up ramp 60 (cf. FIG. 7A) of the webs 32 onto the webs 32, as indicated by an arrow 62. At the same time, the transport item 12-1 is pushed slightly uphill in the positive direction X by the DTV 16 until the transport item 12-1 has reached the second stop 48-2 and/or the transport item 12-2 and is held by them. The transport item 12-2 is held in this position, for example, by the continuous conveyor 14 when the rollers of the continuous conveyor 14 are driven at this moment (or cannot rotate in the opposite direction). The pushing movement of the transport item 12-1 by the DTV 16 is illustrated by an arrow 64 in FIG. 7D.

In FIG. 7E, the DTV 16 has completely entered the receiving station 24. The front edge of the transport item 12-1 rests on the webs 32 of the DTV 16 and its rear edge rests on the transfer conveyor 44. The finger members 34 are still in their lowered positions. Then, for example, the second (shorter) finger 38 can be switched into its raised position, as illustrated in FIG. 7F, without contacting the rear transport item 12-2. In this state, the second finger 38 does not (yet) touch the front transport item 12-1. The DTV 16 then exits the receiving station 24 (in the negative direction X).

FIG. 7G shows the DTV 16 after the DTV 16 has exited the receiving station 24 for the most part. The second finger 38 pushes the transport item 12-1 off the transfer conveyor 44 of the receiving station 24 in the negative direction X, as illustrated by an arrow 66, so that the transport item 12-1 is lowered, as illustrated by an arrow 68, until it rests completely on the LHD 30 of the DTV 16.

In FIG. 7H the DTV 16 has completely exited the receiving station 24. The transport item 12-1 rests completely on the LHD 30. The DTV 16 can then transport the transport item 12-1 by means of a transport travel to any arbitrary destination point. The transport item 12-2 can be conveyed by the continuous conveyor 14 completely onto the receiving station 24 in order to be received by an unloaded (possibly other) DTV 16.

It is preferred that the DTV 16 underpasses the transfer station 20 only, but not the continuous conveyor 14. In this case, an arrangement consisting of the transfer station 20 and the continuous conveyor 14 coupled thereto need a smaller (deployment) space since the DTV 16 does not pass the transfer station 20 upon delivering and receiving, but underpasses it. If the DTV 16 passes through the transfer station 20 during transfer of the transport item 12, the DTV 16 need to be able to underpass the continuous conveyor 14. In this case, the DTV 16 must also emerge again from underneath the continuous conveyor 14 at some point, which produces a larger “footprint” than if the DTV 16 exchanges the transport item 12 with the continuous conveyor 14 by a pilgrim-step movement—hence by a correspondingly coordinated forward and backward travelling.

Even though in general usage a “pilgrim-step movement” is understood as an essentially forward-directed movement consisting of, for example, two steps forward and one step backward, in the present text a movement of the DTV 16 is meant in which the DTV 16 passes only underneath the transfer station 20 (or its transfer conveyor 44), but not underneath the continuous conveyor 14, and then exits again.

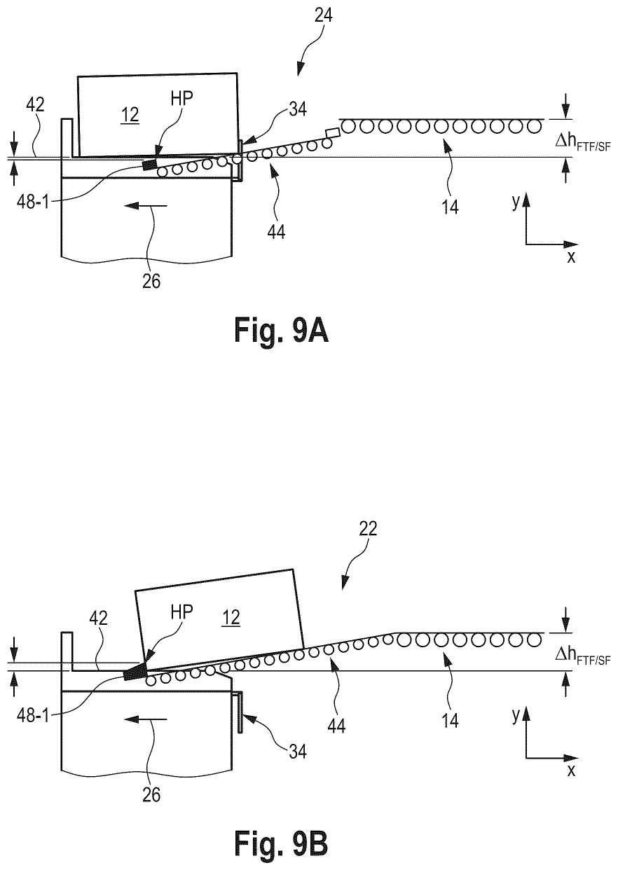

FIG. 9A shows a schematic side view of a receiving station 64 arranged in steps where a vertical step is arranged between the conveying planes of the transfer conveyor 4 and the continuous conveyor 14. The DTV 16 moves out from beneath the transfer conveyor 44 (again) in order to receive the transport item 12. Highest point HP of the lower stop 48-1 is (vertically) lower than the transport surface 42 of the LHD 30.

FIG. 9B shows a schematic side view of a steplessly arranged delivery station 22 where the conveying planes of the transfer conveyor 44 and the continuous conveyor 14 merge into each other steplessly. The transport plane 42 of the LHD 30 is lower than the highest point HP of the stop 48-1. The highest point HP of the stop 48-1 can be an end of the stop 48-1 facing the continuous conveyor 14. The stop 48-1 can have a rising side profile so that the transport item 12 can be pushed gently upward over the stop 48-1 when being delivered (in the positive direction X) from the DTV 16 to the transfer conveyor 44. An end of the stop 48-1 facing away from the continuous conveyor 14 is preferably lower than the transport surface 42 of the LHD 30.

### REFERENCE NUMERALS LIST

### Intralogistics System

12 transport item
14 continuous conveyor
16 DTV
18 DTS
20 transfer station
22 delivery station/first transfer station
24 receiving station/second transfer station
26 travelling direction
28 housing of 16
30 LHD
32 webs/slats
34 finger member
36 1st finger
38 2nd finger
40 additional finger member(s)
42 transport surface
44 transport conveyor
45 frame of 20
46 individual conveyor
48 stop
50 locking device
52 conveying surface of 14
54 removal
56 conveying surface of 24
58 feed
60 start-up ramp of 32
62 lifting movement
64 pushing movement
66 pull-off movement
68 lowering movement

1. A driverless transport system, DTS, comprising:
at least one ramp-like transfer station configured to exchange a transport item with a continuous conveyor horizontally couplable thereto; and
a driverless transport vehicle, DTV, for transporting the transport item from and/or to the at least one transfer;
wherein the DTV comprises a load-handling device forming a flat transport surface on which the transport item rests during a transport travel, wherein the load-handling device has, in an end portion thereof, at least one finger member which is switchable between a raised position and a lowered position, wherein the at least one finger member, in the raised position, protrudes from the transport surface;
wherein each of the transfer stations consists of an inclined non-driven multi-track transfer conveyor being configured to be meshingly underpassed by the DTV so that:
in case, while the transport item rests on the transfer conveyor, the transport item is received by the DTV from the transfer conveyor by the DTV exiting the transfer conveyor and the at least one finger member being in the raised position; and
in case, while the transport item rests on the transfer conveyor, the transport item is delivered by the DTV to the continuous conveyor by the DTV entering the transfer conveyor and the at least one finger member being in the raised position.

2. The driverless transport system of claim 1, wherein
the transfer conveyor is configured to be meshingly underpassed by the DTV so that, in the case, while the transport item rests on the transfer conveyor, the transport item is received by the DTV from the transfer conveyor by the DTV entering the transfer conveyor and the at least one finger member being in the lowered position, and subsequently exiting the transfer conveyor while the at least one finger member is in the raised position.

3. The driverless transport system of claim 1, wherein
the DTV is configured to exchange the transport item with the continuous conveyor by means of a pilgrim-step movement.

4. The driverless transport system of claim 1, wherein
the at least one finger member includes a first finger and a second finger,
the first finger is in its lowered position and the second finger is in its raised position while the DTV receives the transport item from the transfer conveyor, and
the first finger is in its raised position while the DTV delivers the transport item from the transfer conveyor to the continuous conveyor.

5. The driverless transport system of claim 1, wherein
the at least one ramp-like transfer station comprises a first transfer station for delivering the transport item from the DTV to the continuous conveyor, and a second transfer station for receiving the transport item by the DTV from the continuous conveyor.

6. The driverless transport system of claim 5, wherein the transfer conveyor of the first transfer station is couplable to the continuous conveyor in a stepless manner.

7. The driverless transport system of claim 5, wherein the transfer conveyor of the first transfer station comprises a locking device allowing movement of the transport item only in the direction toward the continuous conveyor.

8. The driverless transport system of claim 5, wherein
the second transfer station is configured to be coupled to the continuous conveyor with a step.

9. The driverless transport system of claim 1, wherein the load-handling device comprises, in an opposite end portion thereof, at least one additional finger member protruding from the transport surface.

10. The driverless transport system of claim 1, wherein at a lower end of the transfer conveyor at least one stop is arranged.

11. The driverless transport system of claim 1, wherein the transfer conveyor rises exclusively in the direction of the continuous conveyor.

12. A method for exchanging a transport item between a driverless transport vehicle, DTV, and a continuous conveyor via a ramp-like transfer station consisting of a non-driven inclined transfer conveyor, wherein the transfer station and the DTV are configured to meshingly exchange the transport item while the DTV either enters the transfer station or exits the transfer station, wherein the DTV has a load-handling device, LHD, comprising at its downstream end at least one finger member which, in a raised position, protrudes from a flat transport surface defined by the LHD and, in a lowered position, is positioned below the transport surface; comprising the steps of:
in case of delivering the transport item from the DTV to the continuous conveyor:
meshingly entering the transfer station, by the loaded DTV, parallel to the transfer conveyor until the DTV has completely pushed the transport item onto the transfer conveyor;
subsequently, by the DTV, exiting the transfer station while the at least one finger member is in the lowered position and the transport item rests on the transfer conveyor; and
subsequently, by the DTV, meshingly entering the transfer station again while the at least one finger member is in its raised position until the transport item has been completely pushed, by the at least one finger member, onto the continuous conveyor;
or
in case of receiving the transport item from the continuous conveyor by the DTV:
conveying the transport item, by the continuous conveyor, from the continuous conveyor onto the transfer conveyor of the transfer station;
stopping the transport item on the transfer conveyor;
then meshingly entering the transfer station by the empty DTV while the at least one finger member is in the lowered position until the at least one finger member is positioned behind a rear edge of the transport item and a front edge rests on the LHD;
then moving the at least one finger member from the lowered position into the raised position; and
finally meshingly exiting the transfer station, by the DTV, so that the at least one finger member, in its raised position, pulls the transport item off the transfer conveyor.

13. The method of claim 12, wherein the DTV travels forward during the entering, and travels backward during the exiting, in a direction opposite to the forward direction.

14. The method of claim 12, wherein the continuous conveyor is actively driven in a supporting manner during the delivering, in order to pull the transport item onto itself.

15. The method of claim 12, wherein the continuous conveyor is actively driven in a supporting manner during the receiving, in order to hold the transport item on the transfer conveyor while the initially empty DTV meshingly enters the transfer station.

16. The driverless transport system of claim 4, wherein the first finger in its raised position protrudes higher from the transport surface than the second finger in its raised position.

17. The driverless transport system of claim 9, wherein the additional finger member is immovable.

18. The driverless transport system of claim 10, wherein highest point of the at least one stop is lower than the transport surface of the DTV.

19. The method of claim 12, wherein the continuous conveyor is driven.

20. The method of claim 12, wherein the transport item is passively stopped on the transfer conveyor.
